(19) United States
(12) Patent Application Publication
(10) Pub. No.: US 2017/0350221 A1
(43) Pub. Date: Dec. 7, 2017

(54) METHOD OF SIMULTANEOUS INTRODUCING OF TWO OR MORE THAN TWO CHEMICAL SUBSTANCES AND/OR WATER INTO A SUBTERRANEOUS HYDROCARBON FORMATION AND/OR CONTROL OF THE RATE OF CHEMICAL REACTIONS OF THESE SUBSTANCES, AND A DEVICE FOR IMPLEMENTATION OF THIS METHOD

(71) Applicant: GALEXUM TECHNOLOGIES AG, Cham (CH)

(72) Inventors: Karel KOHLIK, Mellingen (CH); Karel KOHLIK, Campione d'Italie (IT)

(21) Appl. No.: 15/536,459

(22) PCT Filed: Dec. 17, 2014
(86) PCT No.: PCT/IB2015/002363

§ 371 Date: Jun. 15, 2017

(30) Foreign Application Priority Data
Dec. 17, 2014 (CZ) PV 2014-926

(51) Int. Cl. E21B 43/16; E21B 43/24; E21B 34/06; E21B 33/122; E21B 23/06; E21B 19/22; E21B 17/20; C09K 8/594; E21B 47/06; C09K 8/592

(52) U.S. Cl. CPC E21B 43/168; E21B 47/065; E21B 47/06; E21B 43/24; E21B 34/06; C09K 8/592; E21B 23/06; E21B 19/22; E21B 17/20; C09K 8/594; E21B 33/122

(57) ABSTRACT

Method of simultaneous introducing of two or more than two chemical substances and/or water into a subterraneous hydrocarbon formation and/or control of the rate of chemical reactions of these substances, and a device for implementation of this method This invention relates to the method of simultaneous introducing of two or more than two chemical substances and/or water into a subterraneous hydrocarbon formation and/or control of rate of chemical reactions of these substances and/or water by introducing their controlled amount into a subterraneous formation containing liquid and/or gaseous hydrocarbons, particularly crude oil, shale gas or natural, below a dedicated packer for exploration and production of these hydrocarbons and simultaneous inserting of a dedicated data cable (3) for interconnection of the measuring and/or regulating components in the wellbore, where the said chemical substances and/or water are supplied into the wellbore at controlled rate through the free casing (5) by means of at least three mutually separated flexible tubing (2a,b) (flexible injection lines) or the combination of these flexible tubing (flexible injection lines) with the solid wellbore tubing, or by means of at least one flexible multi-channel tubing containing inside at least three fix-attached flexible tubing (channels) of smaller diameter leading into the space in the wellbore and/or pay zone below/behind at least one remotely-adjustable packer connected with the well head that, after reaching the required position, seals off space in the wellbore below the packer and the pay zone (16) against the space above the packer in the wellbore and up to the well head. The invention also includes a device for the implementation of this method.

### FIELD OF THE INVENTION

This invention relates to the method of simultaneous introducing of two or more than two chemical substances and/or water into a subterraneous hydrocarbon formation and/or control of rate of chemical reactions of these substances and/or water by introducing their controlled amount into a subterraneous formation containing liquid and/or gaseous hydrocarbons, particularly crude oil, below a dedicated packer for exploration and production of these hydrocarbons by means of flexible tubing (flexible injection lines). In addition, the invention relates to a device for the implementation of this method.

### STATE OF THE ART

In the effort to increase the output amount of crude oil and/or natural gas (if crude oil does not flow anymore or if crude oil flows at a substantial lower rate out of the reservoir without external support), various methods are used to increase the pressure and/or temperature in oil layers for stimulating its outflow.

According to the state of the art, as it is, for instance, presented in the published international application WO 2010/043239 A1 or published in the international application WO 2012/025150 A1, both of them being included here by reference in the complete form, the crude oil exploration utilities running exothermic reactions of chemical substances in the reaction chamber wherefrom the gases and heat produced by the reaction enable through the increase in the bottom hole pressure and the change in the viscosity to push the crude oil towards the production wells and, possibly, to the surface. The classical arrangement used for supplying chemical substances into the well usually consists of various modifications of three concentric wellbore tubing, namely the casing, outer tubing and inner tubing.

One disadvantages of these methods and pertinent device is that the chemical reaction in the reaction chamber cannot be controlled in a sufficiently simple and dynamic way in relation to both the already running reaction and the supply of additional chemical substances and/or water and/or inhibitor(s) of the said reaction.

In this configuration, the reaction chamber without the packer, which is a special sealing to provide for any injection ability by building up and maintaining a certain pressure and/or temperature at a specific depth in the wellbore without this pressure- and/or temperature raise to build up to the wellhead, a generated temperature and/or pressure in the wellbore is present all the way up to the wellhead on the surface. Furthermore, the lack of using a suitable multi injection tubing and packer combination leads to a lack in safety and drop in efficiency.

The reaction chamber includes a space inside the casing around the perforation that provides for a connection with the hydrocarbon reservoir and is usually located at the end of the casing; the reaction chamber is primarily limited in size and volume by the space between the well bottom and the upper packer.

When a well is completed with several perforations at larger mutual distances, the reaction chamber should be primarily limited by two packers that are set above and below the perforation.

According to published patent application US2011/0203797A1, another of these methods is the method of exploring crude oil by chemical reactions in the so-called reaction chamber and in crude oil layers.

Various chemical substances and water are necessary for the controlled chemical reaction according to this US-application. After dosage, they are primarily fed into the bottom, the so-called reaction chamber, by means of separated injection tubings.

One of the disadvantages of the state of the art in application of the outer and inner tubing is that the lines/data strings for measuring pressure and temperature in the reaction chamber must be installed in a chemical medium under pressure and led out through the inner tubing or through the space between the inner and outer tubing, which results in corrosion of these parts and increases financial demands of the whole well.

According to the state of the art for introducing the chemical substances into the bottom hole reaction chamber, just two pipes are at disposal in the application with the packer, namely the inner tubing and the space between the outer tubing and inner tubing. In order that the chemical reaction could run in an efficient and controllable way, all three chemical substances should be fed into the reaction chamber separately and at the same time. Moreover, water supply into the reaction chamber should be at disposal anytime. This setup thus requires four separate pipes (wellbore tubing) for chemical substances and water.

As just two pipes (as determined by the outer tubing and inner tubing) are at disposal, it is necessary to make compromises. Two chemical substances must therefore be already pre-mixed before injection. Thus, the chemical reaction starts already in the injection tubing and can cause its corrosion and lacks of optimum control.

To provide for water supply, it is necessary to use an injection tubing that is already filled with chemical substances. This means that the whole content of the injection tubing must be discharged into the reaction chamber before water is fed. This procedure prevents continuous control of the reaction.

Increased diameter of the casing causes higher volume of chemicals in the injection tubing, which increases the problem of controlling the reaction process. Moreover, neither of these tubing are fitted with valves at the inlet to the bottom reaction chamber, which makes control of the chemical reaction difficult. Often, the missing inner tubing or also the outer tubing have to be assembled by a standard workover rig.

Therefore, the goal of this invention is to provide a method for introducing and controlling the reaction of chemical substances and/or water in a wellbore for the production of gases and/or seam, that are then further pushed into the reservoir that contains liquid and/or gaseous hydrocarbons, particularly crude oil, natural gas, shale gas etc., that would be, when applied, efficient, simple and relatively cheap, and thus could overcome at least some of the said disadvantages of the prior art.

For this purpose, a suitable device has also been developed according to this invention.

### SUMMARY OF THE INVENTION

The submitted invention provides for a method and the respective device for implementation of this method and that eliminates to a large extent the above said disadvantages of introducing various chemical compounds and/or water into the wellbore and controlling the chemical reaction in the wellbore of a subterraneous hydrocarbon formation according to the mentioned documents of the state of the art.

In particular, according to the provided method and device for its implementation according to this invention, the exploration of liquid and/or gaseous hydrocarbons or their mixtures does not require the use of an outer and an inner tubing.

In this invention, liquid and gaseous hydrocarbons are defined as hydrocarbons of chain lengths C₅-C₁₆ and/or of chain lengths C₁-C₄ and their mixtures, such as crude oil, natural gas or shale gas, etc.

According to the present invention of the method, three chemical substances and/or water are fed through separated flexible tubings (flexible injection lines), through the casing into the reaction chamber behind the packer. In order to provide for even better dosage of the chemicals, i.e., in particular, control of their flow rate into the well, the flexible tubings (flexible injection lines) are preferably connected with the reaction chamber via control valves and/or non-return valves.

Hence, the principle of this invention is the method of simultaneously introducing two or more than two chemical substances and/or water into the pay zone of a subterraneous hydrocarbon formation and/or control of the chemical reaction speed of these substances and/or water by introducing a controlled and optimum amount of these chemicals and/or water in order to control the respective gas and/or steam production whereas the produced gases and/or steam is further being introduced into the pay zone of the subterraneous hydrocarbon formation by means of vertical or horizontal wells in order to enable or increase the production of gaseous hydrocarbons and/or liquid hydrocarbons, particularly crude oil, shale gas or natural gas, and by further simultaneously inserting a data logging cable for the interconnection of the measuring and/or controlling elements in the well; the said chemical substances and/or water are fed into the wellbore at controlled injection rate and mixing rate through the casing by using at least three introduced and separated flexible injection tubings (flexible injection lines) or by using a combination of these flexible tubings with a rigid tubing, or by using at least one flexible multi-channel-tubing containing inside at least three flexible feed through lines of smaller diameter leading into the wellbore below/behind at least one remotely-adjustable packer and that is connected with the well head that is, after reaching the required position in the wellbore, sealed off in order to maintain the pressure resistance in the wellbore up to the wellhead.

In the preferred method according to this invention, the remote shifting of the packer for horizontal wells can be carried out by means of its own drive, flexible injection tubings (injection lines), at least one multi-channel-tubing, a rigid tubing for the exploration of the hydrocarbons, in combination with flexible injection tubing (flexible injection lines), whereas this packer can be set in the wellbore (casing) by a suitable packer setting string, or hydraulically, or by means of a device generating electric impulses in order to set the packer.

In addition, the method according to the invention can be applied to produce both gaseous hydrocarbons of chain length C₁-C₄ and liquid hydrocarbons of chain length C₅-C₁₆ or their mixtures, such as, in particular, crude oil, natural gas, shale gas, etc.

According to this invention, the near wellbore area in the pay zone of a subterraneous hydrocarbon formation and in the vicinity of the perforation, together with the space between the bottom of the well and the bottom of the packer is considered as the reaction chamber and also as reaction starting chamber, whereas in this chamber the chemical reaction in order to produce gases and/or steam to enable and/or stimulate the hydrocarbon production is started.

According to the method of the submitted invention, the flexible injection tubing (flexible injection lines) or their combination with the rigid tubing or at least one flexible multi-channel-tubing ideally contain the control and/or regulating components together with the temperature and/or pressure sensors, and with a suitable data cable, connected to and channeled through at least one packer (ideally a so called feed-through packer), are preferably lowered to the required and pre-determined depth in the vertical well, for instance on a suitable steel rope (wireline), by flexible injection tubing (flexible injection lines) or attached to a solid production tubing or small solid tubing that later on also serves as injection tubing, and subsequently they are attached to and potentially sealed off on one or on the two ends of the packer and sealed against the casing, for instance, with an elastic sealing. In addition, it is possible and sometimes preferred to lower the flexible injection tubing (flexible injection lines) into the well on the solid standard tubing used for crude oil exploration.

According to the invention, it is also preferred for the horizontal well when the flexible injection tubing (flexible injection lines) or their combination with the solid standard tubing (production tubing), or at least one flexible multi-channel-tubing ideally contain the control and/or regulating components together with the temperature and/or pressure sensors, and with a suitable data cable, connected to and channeled through at least one packer (ideally a so called feed-through packer), are preferably lowered to the required and pre-determined depth and/or position in the horizontal well for instance on a suitable steel rope (wireline), by flexible injection tubing that are also able to be inserted into and through the curve of the horizontal well (flexible injection lines) or attached to a solid production tubing or small solid tubing that later on also serves as injection tubing, and subsequently they are attached to and potentially sealed off on one or on the two ends of the packer and sealed against the casing, for instance, with an elastic sealing. In addition, it is possible and sometimes preferred to lower the flexible injection tubing (flexible injection lines) into the horizontal well on the solid standard tubing used for crude oil exploration, especially when the casing is only set vertically on a horizontal well.

In the preferred method according to the invention, the packer is remotely-shifted, which can be carried out by means of its own drive, flexible tubing, multi-channel-tubing or by as suitable wireline system, or hydraulically or by means of a suitable packer setting device generating electric impulses in order to set the packer.

The particularly preferred solution according to the invention is the embodiment in which the second packer is shifted together with the first packer through the free casing to the required position in order to seal the pay zone from the opposite side; the perforation in the casing with the outlet into the hydrocarbon formation is thus preferably located between two dedicated packers by means of an interconnection distance element that ensures the proper distance between the packers and the movability of the whole double—packer—injection system.

In the preferred embodiment according to the invention, the chemical substances are, before they enter the pay zone, mixed together or mixed with water or the substance acting as the reaction retarder.

The flow rate of the chemical substances and/or water or the substance acting as the reaction retarder for controlling the rate of the chemical reaction in the wellbore and/or in the pay zone is regulated based on a data feedback by the sensors, particularly by monitoring temperature and/or pressure in the wellbore above and/or below the packer.

As to the suitable chemical substances that are introduced into the wellbore below the packer and/or the pay zone, any chemical substances known according to the state of the art can be used, preferably those that include the groups of compounds named as TGEC, (i.e. composition producing source of heat and gases), such as, in particular, nitrates of alkali metals, alkaline earth metals, nitrates of salts of various organic acids, etc. and/or RIS (i.e. compounds initiating and stabilizing reactions with TGEC), such as various borates, boranes, aluminates or alanes, etc.; these compounds are mentioned in details, for instance, in published international application WO 2010/043239.

The applied retarders of thermo-chemical reactions (inhibitors) are commonly known and available to a chemist-expert in the field of the state of the art, see, for instance, suitable pages on Internet.

The method of exploring and producing hydrocarbons (i.e. crude oil, gas, etc.) from a subterraneous hydrocarbon formation as preferred by the invention utilizes the combination of flexible tubing (flexible injection tubing) in combination with a solid tubing (standard production tubing as for instance API 2⅞″-tubing or small solid standard field tubing as for instance API 1″-tubing); the said chemical substances, water or substances acting as the reaction retarder are supplied through the flexible tubing (flexible injection lines) and the explored hydrocarbon are ideally produced through the solid tubing (standard production tubing as for instance API 2⅞″-tubing). In case a small API 1″-tubing is being used, it serves as holding tubing and, after setting the packer, as injection tubing.

A further subject of the invention is a device for simultaneously introducing more than two chemical substances and/or water into the pay zone of a subterraneous hydrocarbon formation, and/or for controlling the rate of the initiated chemical reaction of the used substances by introducing a controlled amount into the wellbore below the packer and/or into the pay zone, into vertical or horizontal wells, in order to explore and/or produce gaseous hydrocarbons and/or liquid hydrocarbons, particularly crude oil, shale gas or natural gas, and that is designed for the purpose of ideally implementing the above described method; whereas it includes:

a) the casing in a wellbore with the perforations located at an ideal point of the pay zone; inserted into this wellbore is at least one remotely-settable packer connected with the well head through a string-setting-mechanism or through a rigid-hydraulically-suitable-tubing or through a mechanical-tubing-setting or through by a trigger-cable that guides the electronic-setting-mechanism; the packer has the sealing head installed on its top and is on at least one part of its side surface fitted with a suitable elastic high temperature sealing, and

b) at least three mutually separated flexible tubing (flexible injection lines) or a combination of these flexible tubing (flexible injection lines) with a standard solid tubing, or; at least one flexible multi-channel-tubing containing at least three sealed-off channels of smaller diameter and/or data-lines;

for supply and/or regulation of the said chemical substances, and for the data cable connecting the pressure and/or temperature and/or ph-value measuring sensors and/or controllable components located below/behind this packer, whereas this packer comprises one or several sealed-off feed-through-channels/feed-through-bores to which the various flexible tubing (flexible injection lines) and/or standard solid tubing and/or flexible multi-channel-tubing are attached and/or passed through below/behind this packer and into the direction of the pay zone, ideally shortly above the perforation.

According to this invention, woven stainless-steel or suitable plastic/rubber hoses, preferably mixed with or made out of PTFE (Teflon), are ideally used as flexible tubing (flexible injection lines).

Preferred embodiment according to the invention is the flexible multi-tubing containing at least four mutually separated and fix-attached flexible tubing (injection lines) of smaller diameter; whereas this multi-tubing includes:

the first tubing for supplying basic chemical substance;

the second tubing for supplying initiating and stabilizing chemical substances;

the third tubing for supplying water and/or substances acting as the reaction retarder; and

the fourth tubing for introducing the cable for interconnection of the measuring or regulating components in the well.

More preferably, the flexible tubing of smaller diameter inside the flexible multi-tube are mutually fix-attached by filling the remaining space with the flexible material resistant against external pressure, based, for instance, on silicone (flexible multi-channel-tubing).

Preferred embodiment according to the invention is the device when, for shifting the remote-adjustable packer in the horizontal well, the packer is fitted with the hydraulic or electric drive, or contains additional auxiliary device for shifting on the rope or shifting by means of the flexible tubing where the drive is outside the well; the elastic sealing of the packer against the casing can be controlled mechanically, hydraulically, or by means of impulses of electric current.

According to the invention, preferred embodiment of the packer is when additional holes are made in its sealing head for installing the temperature- and/or pressure-sensors or for their passage to the place of monitoring temperature and/or pressure.

According to the invention, the flexible tubing (flexible injection lines) or flexible multi-channel tubing can be detachably attached directly to the sealing head of the packer; however, preferred solution of the device is the embodiment in which, for dosage and/or control of the said chemical substances and/or water into the pay zone, these flexible tubing (flexible injection lines) or flexible multi-channel tubing are connected to the pay zone via the control and/or regulation components by means of the sealing head of the packer.

The control and/or regulation components are preferably control valves and/or non-return valves fix-attached to the sealing head of the packer; the control and/or regulation components, flexible tubing or flexible multi-channel tubing, and sensors of temperature and pressure can be fixed, in addition to the packer head, preferably also in the packer itself.

Further preferred embodiment of the device includes the mixer externally connected at the end of the flexible tubing (flexible injection lines) or flexible multi-channel tubing that mutually interconnect these hoses or the flexible tubing (flexible injection lines) of smaller diameter for stirring the said chemical substances, more preferably with a connected stirrer, for their mixing before the reaction chamber (where the reaction is also ignited), i.e. below the packer in the wellbore and/or in the subterraneous hydrocarbon formation.

In the particularly preferred embodiment according to the invention, the end of at least one of the flexible tubing (flexible injection lines) or flexible multi-channel tubing inside the well is fitted with a pump for pumping oil from the well and/or providing for a gas outlet.

Considering the applied pressures and temperatures in the well, the securing element can be installed on the well surface in the direction perpendicular to the casing as the uppermost part of this device that is attached at the upper edge of the casing and seals the space above the packer against the atmosphere. In addition, the securing element can be used for the case of accident that is also attached at the upper edge of the casing and, in the case of accident, it cuts off the flexible tubing (flexible injection lines) and, for instance, the suspension rope, and seals the well against the atmosphere.

According to another of preferred embodiments of the invention, a special adaptor with one or more passages attached below the head or in the head of the well can be used for leading out and sealing the flexible tubing (flexible injection lines) or flexible multi-channel tubing.

For more detailed explanation of the subject of the invention, the following figures are presented that, however, do not in any way limit the scope of the invention defined by the below given Claims.

### BRIEF DESCRIPTION OF DRAWINGS

FIG. 1 shows schematic representation of the device according to the invention in the vertical well with one packer;

FIG. 2 shows schematic representation of the device according to the invention in the horizontal well with two packers;

FIG. 3 shows schematic representation of the device according to the invention—flexible multi-channel tubing in cross-section containing inside four mutually separated fix-attached flexible tubing and/or channels of smaller diameter.

### EXPLANATION OF REFERENCE MARKS

1: steel rope (wireline)
2a: 1st flexible tubing (flexible injection line)
2b: 2nd flexible tubing (flexible injection line)
3: cable of temperature and/or pressure sensor
4: securing element
5: casing (boring tube)
6: valves
6′: non-return valves
7: sealing head of packer
8: elastic sealing
9: packer
9a: 1st packer
9b: 2nd packer
10: perforation
11: mixer with stirrer
12: chemical substances
13: reaction chamber
14: packer drive
15: distance and control element
16: pay zone (active production zone in subterraneous hydrocarbon formation)
17a: 1st pulley
17b: 2nd pulley

### EXAMPLES

### Example 1

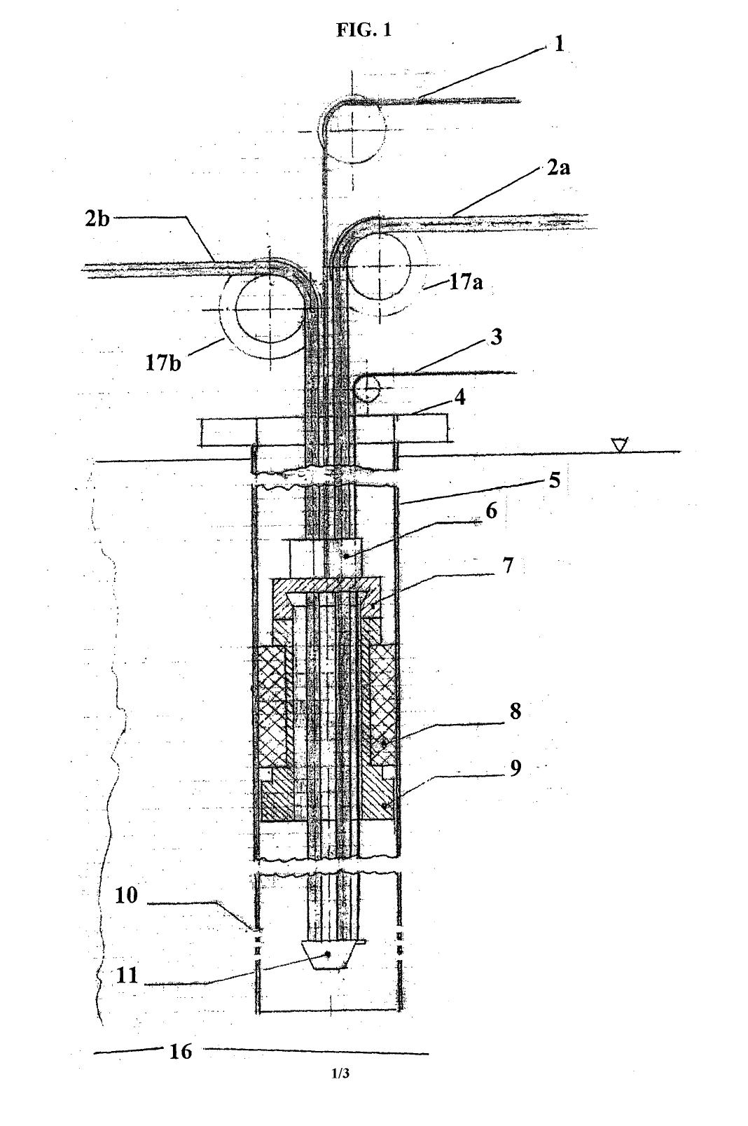

The device according to FIG. 1 for the vertical well consists of casing (bore tubing) 5 terminated before the end with perforation 10 connecting the well with pay zone 16—crude oil. Inside casing 5 secured on the top just above the ground with securing element 4 there is remote-adjustable packer 9 which hangs, for instance, on controllable steel rope (wireline) 1 and which is closed on the top with sealing head 7; elastic sealing 8 is made on a part of the packer outer surface in longitudinal direction. Valves 6 and/or non-return valves 6′ are fix-attached on sealing head 7 of packer 9. Both valves 6 and/or non-return valves 6′, and sealing head 7 on packer 9 and packer 9 are adapted for passage of cable 3, connected with the temperature and/or pressure sensor, and two or more flexible tubing (flexible injection line.) 2a and 2b leading below packer 9. Mixer with stirrer 11 is connected at ends of all flexible tubing (flexible injection line) 2a, 2b behind the packer 9.

According to the method of the submitted invention for the open vertical well, packer 9 together with the flexible hoses/tubing, led over pulleys 17a, 17b, which are, for instance, flexible tubing (flexible injection lines) 2a, 2b, and with the cable of measuring sensors 3 of temperature and pressure are lowered, for instance, on steel rope (wireline) 1 through casing (boring tube) 5 to the required position and, after reaching it, packer 9 is fixed in casing 5 by means of elastic sealing 8. The chemical substances and/or water are fed below packer 9 via separated flexible tubing (flexible injection line) 2a, 2b connected below packer 9. For better dosage and/or control of these chemical substances and/or water into pay zone 16 with crude oil, including, in particular, the reaction chamber interconnected with deposit 16 by perforation 10, flexible tubing (flexible injection line) 2a, 2b are preferably led via the controllers, i.e. valves 6 or non-return valves 6′.

By this method, the packer controlled, for instance, hydraulically separates the well with exploited crude oil from the surrounding atmosphere.

### Example 2

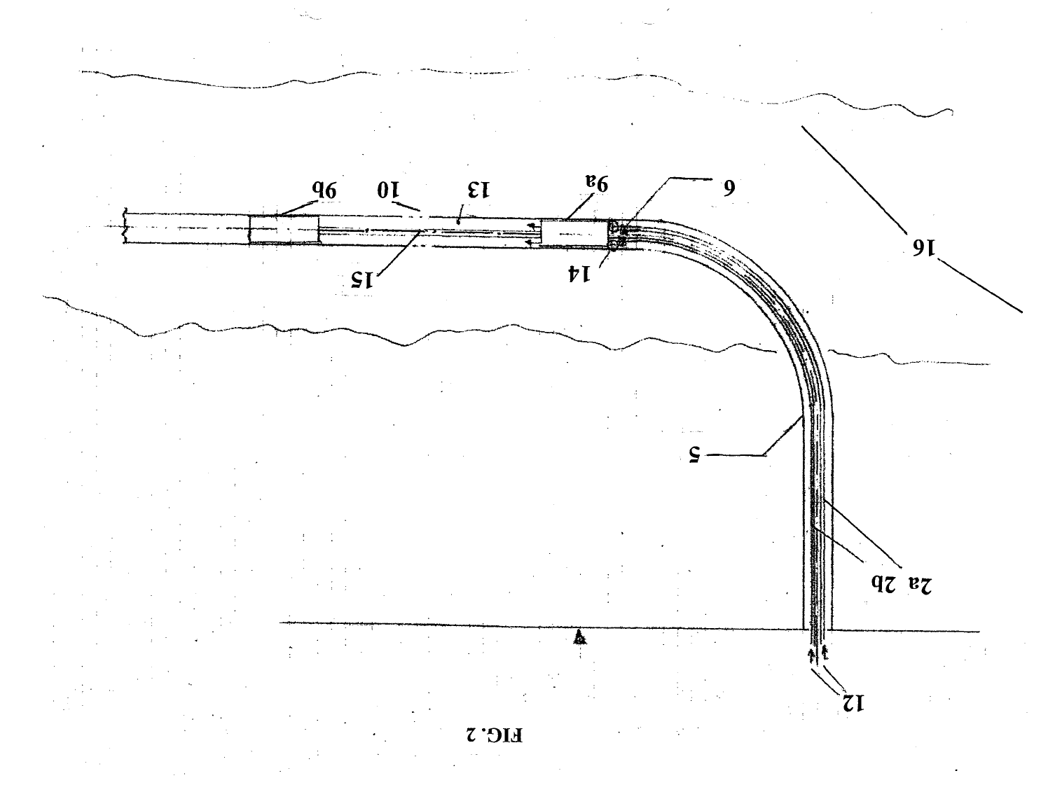

The device similar to that in Example 1 is also utilized for the open horizontal well (with possibly built-in securing element 4, (see FIG. 1)), with one or more perforations; however, two packers 9a and 9b inserted into the well are mutually connected by distance and control element 15, as shown in FIG. 2.

The system of two packers 9a and 9b is inserted into horizontal casing 5 using the flexible tubing (flexible injection line) or multi-channel tubing (i.e. coiled-tubing), or own drive 14 of packer 9a; however, second packer 9b acts as a sealing component only, i.e. without any additional device. When the required distance is reached at which the perforation is located between both packers 9a and 9b, both packers are sealed. Perforation 10 connected with pay zone 16 and reaction chamber 13 is thus located between both packers 9 and 9a, as shown in FIG. 2.

The chemical substances are then fed through the flexible tubes via the control elements (valves) and via packer 9a into the reaction chamber between both packers where the required reaction takes place, as shown in FIG. 2.

### Example 3

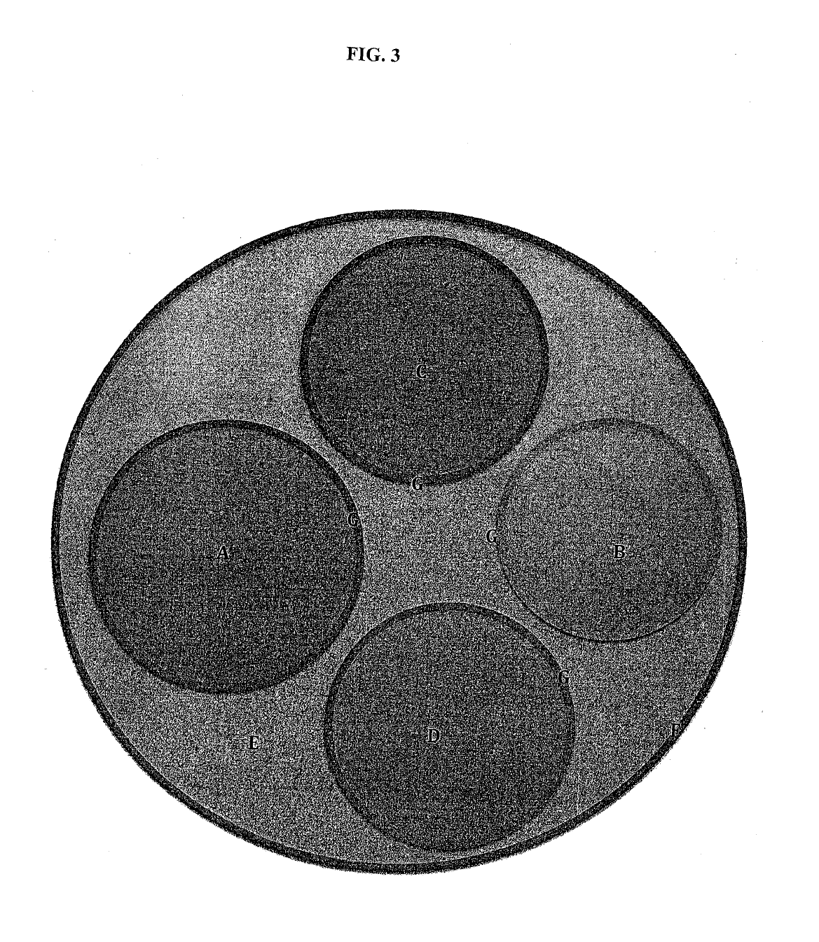

The device used for exploration of crude oil according to FIG. 3 is shown in cross-section in the form of flexible multi-channel tubing woven with stainless-steel fibres with outer jacket F, resistant against pressure of 68.948 to 82.737 MPa (10,000 to 12,000 psi) and temperature up to about 250° C., for simultaneous introducing of three chemical substances and/or water and inserting cables into the vertical or horizontal well of the casing diameter 0.127 to 0.178 m (5 to 7 inches).

Length of this multi-channel tubing was 1,500 m, however, it can be even longer.

This multi-channel tubing contained inside four fix-attached flexible tubing of smaller diameter leading into the space of the pay zone below/behind at least one remote-adjustable packer.

The first flexible tubing (injection line) marked A with outer jacket G of diameter 18 to 20 mm, was used for introducing the basic chemical substance TGEC, i.e. the composition producing the source of heat and gases.

The second flexible tubing (injection line) marked B with outer jacket G of diameter at least 15 mm was used for leading the cables to one or two thermocouples or to the cable monitoring thermal conditions inside the well, one underground pressure sensor cable, and/or for one pressure cable of the sensor of the upper well hole and/or for one cable to the regulating valve in the vertical well.

The third flexible tubing (injection line) marked C with outer jacket G of diameter approximately 14 to 17 mm was used for introducing the chemical substance (RIS) initiating and stabilizing the reaction with the basic chemical substance.

The fourth flexible tubing (injection line) marked D, with outer jacket G, of diameter approximately 14 to 17 mm was used for introducing the reaction inhibitors, such as water or the chemical substance functioning as the reaction retarder (inhibitor).

Remaining internal space marked E delimited by the jacket of the flexible multi-channel tubing and the said first to fourth tubes A-D was filled with a flexible material based on silicone so that the multi-channel tubing would be resistant against external pressure.

### INDUSTRIAL APPLICABILITY

The method and device according to the invention makes it possible to quickly, efficiently and much more safely fill and/or control the chemical substances during their reaction in the wellbore below a dedicated packer and/or in the pay zone (active production zone) of a subterraneous hydrocarbon formation.

The said method and device with its design enable all lines and/or data cable(s) to be fully inert and/or coated against any corrosive substances and that can be even located in the environment of water above a water flooded packer, which substantially simplifies using, for instance, monitoring devices for temperature and/or pressure measurement below and/or above the packer(s) and, in this way, the price of the device is subsequently favorably influenced.

In addition, the device facilitates easy assembly and disassembly, i.e. it can be quickly and at low costs transported to another well, irrespective of whether the device is being lowered into the wellbore by steel rope (wireline) and/or by hanging the device on a suitable solid wellbore tubing (i.e. 2⅞″-tubing, 2⅜″-tubing, 1″-tubing, 0.75″-tubing, etc.).

1. A method of simultaneous introducing of two or more than two chemical substances and/or water into the wellbore space below a packer and/or pay zone of a subterraneous hydrocarbon formation and/or controlling rate of chemical reactions of these substances and/or water by supplying their controlled amount into the wellbore spacing below a packer and/or pay zone of a subterraneous hydrocarbon formation through vertical or horizontal wells for the purpose of exploration and production of gaseous hydrocarbons and/or liquid hydrocarbons, particularly crude oil, shale gas or natural gas, and simultaneous inserting of the cable for interconnection of measuring and/or regulation components in the wellbore, characterized in that the said chemical substances and/or water are supplied into the wellbore spacing below a packer and/or pay zone of a subterraneous hydrocarbon formation at controlled rate through the free casing by means of at least three mutually separated flexible tubing (flexible injection lines) or combination of these flexible tubing (flexible injection lines) with the solid wellbore tubing, or by means of at least one flexible multi-channel tubing containing inside at least three fix-attached flexible tubing of smaller diameter leading into the space of the wellbore below/behind at least one remotely-adjustable packer and/or into the pay zone of a subterraneous hydrocarbon formation, connected with the well head that, after reaching the required position, seals off the pay zone together with the well space below the packer.

2. The method according to claim 1, characterized in that the packer in the horizontal well is remotely-adjusted by means of its own drive, flexible tubing (injection lines), multi-channel tubing, solid wellbore tubing in combination with flexible tubing (injection lines), by a suitable packer setting string, or hydraulically, or by means of a device generating electric impulses to drive the packer setting mechanism.

3. The method according to claim 1, characterized in that the said flexible tubing (flexible injection lines) or their combination with the solid wellbore tubing or at least one flexible multi-channel tubing, that also contain the cable for interconnecting measuring and/or regulation components, together with the temperature and/or pressure sensors, and with at least one packer are lowered, particularly on a suitable rope (wireline) to the required depth of the open vertical well and, subsequently, they are fixed on the outer surface of the packer against the free casing using elastic sealing.

4. The method according to claim 1, characterized in that the said flexible tubing (flexible injection lines) or their combination with the solid wellbore tubing, or at least one flexible multi-channel tubing, that contain the cable for interconnection of measuring and/or regulation components, together with the temperature and/or pressure sensors, and with at least one packer are shifted to the required position of the open horizontal well by means of the packer drive or by shifting on flexible pipes (flexible wellbore tubing) and, subsequently, they are sealed off on the outer surface of the packer against the free casing using elastic high-temperature and/or high-pressure sealing.

5. The method according to claim 4, characterized in that, together with the first packer, the second the packer is shifted through the free casing to the required position for sealing off the pay zone from the opposite side; the perforation of the casing connected with the outer pay zone is located between them.

6. The method according to any of claims 1 to 5, characterized in that the said chemical substances are, before entering into the space below the packer in the wellbore and/or the pay zone of the subterraneous hydrocarbon formation, mutually mixed or mixed with water or substances acting as reaction retarder.

7. The method according to any of claims 3 to 6, characterized in that the flow rate of the chemical substances and/or water or the substances acting as reaction retarder for controlling rate of chemical reactions in the space below the packer in the wellbore and/or the pay zone of the subterraneous hydrocarbon formation is controlled based on feedback of the applied wellbore sensors, particularly of the temperature and/or pressure sensors located below the packer in the wellbore and/or the pay zone of the subterraneous hydrocarbon formation.

8. The method according to any of the claims 1 to 7, characterized in that the said chemical substances are selected from the group of compounds including basic chemical substances—TGEC, i.e. compositions producing source of heat and gases, such as alkali metal nitrates, alkaline metal earth nitrates, salts of various organic acid nitrates, and/or RIS, i.e. chemical substances initiating and stabilizing the reaction with TGEC, such as various borates, boranes, aluminates or alanes.

9. The method according to claims 1 to 8, characterized in that, in the combination of the flexible tubing (flexible injection lines) with the solid wellbore tubing, the said chemical substances and/or water are supplied via the flexible tubing (flexible injection lines) and the explored hydrocarbons are produced through the solid wellbore tubing.

10. A device for simultaneous introducing of two or more than two chemical substances and/or water into the wellbore space below a packer and/or pay zone of a subterraneous hydrocarbon formation, and/or for controlling the rate of chemical reaction of these substances by introducing their controlled amount into the wellbore space below a packer and/or pay zone of a subterraneous hydrocarbon formation through a vertical or horizontal well for the exploration and production of gaseous hydrocarbons and/or liquid hydrocarbons, particularly crude oil, shale gas or natural gas, using the method according to any of claims 1 to 9, characterized in that it includes:
a) the outer casing fitted in the vicinity of its end at the pay zone with the perforation; at least one remotely-adjustable packer connected by flexible tubing (injection lines) and/or data cable with the well head, is inserted into the casing; the packer with the sealing head installed on its top is fitted with elastic sealing on at least a part of its side surface, and
b) at least three mutually separated flexible tubing (flexible injection lines) or combination of these flexible tubing (flexible injection lines) with the solid wellbore tubing, or at least one flexible multi-channel tubing containing at least three fix-attached flexible tubing (flexible injection lines) and/or channels of smaller diameter,
for supply and/or control of the said chemical substances, and for the cable interconnecting the measuring sensors or regulation components, below/behind this packer, with the detachable inlet into the sealing head of the packer, passing through the packer with the outlet below/behind this packer, in the direction to the pay zone.

11. The device according to claim 10, characterized in that the flexible multi-channel tubing contains inside at least four mutually separated fix-attached flexible tubing (channels) of smaller diameter; the multi-channel tubing includes:
the first tubing (channel) for supplying the basic chemical substance;
the second tubing (channel) for supplying the initiating and stabilizing chemical substance;
the third tubing (channel) for supplying water and/or the substance acting as the reaction retarder; and
the fourth tubing (channel) for introducing the cable for interconnecting the measuring or regulation components in the well.

12. The device according to claim 10 or 11, characterized in that the flexible tubing (flexible injection lines) inside the flexible multi-channel tubing are mutually fix-attached by filling the remaining space with a flexible material based, for instance, on silicone resistant against external pressure.

13. The device according to claim 10, characterized in that, for shifting the remotely-adjustable packer in the horizontal well, the packer is fitted with hydraulic or electric drive or it includes additional auxiliary device for shifting on the rope (wireline) or shifting by means of flexible pipes (flexible wellbore tubing), whereas the drive is out of the well; the elastic sealing of the packer against the casing can be controlled by a suitable packer setting string, or hydraulically, or by means of a device generating electric impulses to drive the packer setting mechanism.

14. The device according to claim 10, characterized in that the sealing head of the packer contains additional holes (NPT-bores) for installing the sensors for temperature and/or pressure measurement, or for enabling the channeling of the temperature and/or pressure sensor cable below the packer.

15. The device according to claim 10 or 14, characterized in that, for dosing the said chemical substances and/or water into wellbore space below a packer and/or pay zone of a subterraneous hydrocarbon formation, the flexible tubing (flexible injection lines) or combination of these flexible tubing (flexible injection lines) with the solid wellbore tubing, or the flexible multi-channel tubing are connected to and sealed off against the wellbore space below a packer and/or pay zone of a subterraneous hydrocarbon formation by means of the sealing on the head of the packer and via the control and/or regulation components attached on the sealing head of the packer.

16. The device according to claim 15, characterized in that the control and/or regulation components are control valves and/or non-return valves.

17. The device according to claims 10 to 16, characterized in that the control and/or regulation components, flexible tubing (flexible injection lines), or the combination of these flexible tubing (flexible injection lines) with the solid wellbore tubing, or flexible multi-channel tubing, the temperature and/or pressure sensors are, in addition to the packer head, also fixed and sealed off in the packer.

18. The device according to claims 10 to 17, characterized in that it contains, below (vertical setting) or behind (horizontal setting) of the packer, preferably at the end of the flexible tubing (flexible injection lines) or flexible multi-channel tubing, the mixer, possibly with a stirrer, mutually interconnecting the pre-separated tubing (channels) for stirring the chemical substances.

19. The device according to claim 10, characterized in that the remotely-controllable packer separates and seals off against the wellbore space below the packer and/or pay zone of a subterraneous hydrocarbon formation from the external atmosphere below the wellhead and above the packer (1-packer-application) and/or also below the packer (2-packer-application) in the wellbore.

20. The device according to any of claims 10, 15 or 17 to 18, characterized in that the flexible tubing (flexible injection lines) or flexible multi-channel tubing are woven stainless-steel hoses or hoses made of plastic, preferably of PTFE (Teflon).

21. The device according to claim 10, characterized in that the securing element is installed on the well surface in the direction perpendicular to the casing.
